(19) United States
(12) Patent Application Publication
(10) Pub. No.: US 2008/0231160 A1
(43) Pub. Date: Sep. 25, 2008

(54) Universal cooling points compact fluorescent lamps

(76) Inventor: Ellis Yan, Aurora, OH (US)

Correspondence Address: JOSEPH H. TADDEO;ATTORNEY AT LAW, The Timberwood Office, 3446 Timberwood Trail, Richfield, OH, 44286-9755, US

(21) Appl. No.: 12/082,612

(22) Filed: Apr. 14, 2008

Related U.S. Application Data
(63) Continuation-in-part of application No. 11/049,965, filed on Feb. 4, 2005, now Pat. No. 7,358,656.

(51) Int. Cl. H01J 61/52; H01J 1/62

(52) U.S. Cl. 313/44; 313/493

(57) ABSTRACT

A low-wattage, bi-helically shaped, compact fluorescent lamp, having preferably a wattage rating of preferably 23-watts, to sustain constant luminous output when the lamp is mounted in either in an upright position or mounted lying in the horizontal plane, by the unique placement of two cooling point chambers on the periphery of the bi-helical lamp, where at each cooling point chamber there is a drop in pressure of the mercury vapor that results in a drop in temperature, in accordance with Gay-Lussac's Law. In an alternative configuration, a medium wattage compact fluorescent lamp performs ideally by using three cooling points chambers, whereas higher wattage sized lamps perform best utilizing preferably four to five cooling point chambers. Hence, the plurality of cooling point chambers required for omni-directional mounting of the lamp is functional with the physical size of the lamp, its wattage rating, the quantity of mercury needed and the placement of each cooling point chamber.

### CLAIM FOR THE BENEFIT OF PREVIOUS APPLICATIONS

This is a continuation-in-part (CIP) patent application, wherein Applicant claims the benefit of Utility patent application Ser. No. 11/049,965, filed on behalf of the same inventor, Ellis Yan, on Feb. 4, 2005, now U.S. Pat. No. 7,358,656, issued Apr. 15, 2008.

### FIELD OF INVENTION

The present invention relates primarily to compact fluorescent lamps and, more particularly, to dual spirally wound compact fluorescent lamps having a plurality of cooling points that are strategically placed along the periphery, which provides an equivalent lamp intensity when the lamp is operated in either an upright vertical position or in a horizontal plane. The lamp is provided with a cold chamber portion connecting the ends of the spiral shaped tube portions at the apex and a plurality of cold chambers positioned on each leg of the distal ends.

### BACKGROUND OF THE INVENTION

The optimum mercury vapor pressure for producing a radiation of 2537 angstroms to excite a phosphor coating the interior of a fluorescent lamp approximates six millitorr, at a corresponding mercury vapor temperature approximating 40 degrees C. To ensure optimum operation of the lamp at or about a mercury vapor pressure of six millitorr, the power density level of a conventional fluorescent lamp is adjusted to attain this result. A typical range of operating pressures may span from between four to seven millitorr. The lamp is typically designed such that the coolest location, (cooling point), in the fluorescent lamp is approximately 40 degrees C.

Compact fluorescent lamps, however, operate at higher power densities with the cold spot temperature typically exceeding 50 degrees C. As a result, the mercury vapor pressure is higher than the optimum four to seven millitorr range, and the luminous output of the lamp is decreased.

One consideration in controlling the mercury vapor pressure is to use an alloy capable of absorbing mercury from its gaseous phase in varying amounts, depending upon temperature. Alloys capable of forming amalgams with mercury have been found to be particularly useful. The mercury vapor pressure of such an amalgam at a given temperature is lower than the mercury vapor pressure of pure liquid mercury.

Positioning an amalgam to achieve a mercury vapor pressure in the optimum range remains difficult. For stable long-term operation, the amalgam should be placed and retained in a relatively cool location with minimal temperature variation. Such an optimal location is at or near the tip, or apex, of the lamp envelope.

As a practical solution, the amalgam support should maintain the optimal location of the amalgam, regardless of the orientation of the lamp.

The following prior art discloses the various aspects in the design of spirally shaped cold cathode fluorescent lamps.

U.S. Pat. No. 5,500,567, granted Mar. 19, 1996, to R. H. Wilson, et al., discloses an apparatus for securing an amalgam at the apex of an electrodeless fluorescent lamp, having a glass rod extending through and sealed to the exhaust tube of an electrodeless SEF fluorescent discharge lamp that has a metal support member at one end thereof for supporting an amalgam at or near the apex of the lamp envelope. The metal support member may comprise a spiral-shaped wire, a wire screen, or a wire basket. Preferably, the amalgam is maintained in contact with the apex of the lamp envelope. If desired, the metal support member may comprise a magnetic material to allow for magnetic transport of the amalgam assembly during lamp processing. The metal support member restricts spreading of the amalgam when in a liquid state; and the glass rod provides rigid support for the amalgam independent of lamp orientation.

U.S. Patent Application No. 20020180352, filed Dec. 5, 2002, by L. Ilyes, et al., discloses a low-pressure discharge lamp with a double spiral shaped discharge tube including two spiral shaped tube portions. The tube portions define a central axis of the discharge tube. A cold chamber portion connects the ends of the spiral shaped tube portions. The cold chamber portion has a first transversal dimension substantially perpendicular to the central axis, which is larger than the diameter of the tube portions. The cold chamber portion further has a second transversal dimension substantially parallel to the central axis. The second transversal dimension of the cold chamber portion substantially corresponds to the diameter of the tube portions.

U.S. Pat. No. 6,528,953, granted Mar. 4, 2003, to N. Pearson, et al., discloses an Amalgam retainer having an arc discharge lamp comprised of an arc chamber having an amalgam tip attached to and communicating with it. The communication comprises a narrow tubular extension that penetrates the amalgam tip for a distance less than the depth of the tip. An amalgam that includes bismuth is contained within the amalgam tip. This construction allows operation of the lamp in any position and prevents the bismuth in the amalgam from penetrating the lamp and poisoning the phosphor.

U.S. Pat. No. 6,630,779, granted Oct. 7, 2003, to J. Tokes, et al., discloses a fluorescent lamp comprised of a discharge tube bent substantially in a plane and shaped at least in part to define a substantial portion of the boundary of a zone in the plane. The part of the tube defining the boundary includes at least one straight portion. The discharge tube has a central axis and sealed ends provided with electrodes and at least two tube sections running substantially parallel to each other. Each tube section has at least one blind-sealed end and the tube sections are connected in series through bridges in the vicinity of the blind-sealed ends to define a single continuous discharge space to be excited by electrical power supplied to the electrodes. A lamp support housing is positioned within the zone and the ends of the discharge tube as well as the blind-sealed ends of the tube sections are re-entrant into the zone. The ends of the discharge tube are received in the lamp support housing. The lamp support housing carries means suitable for mechanically and electrically connecting to a socket and include lead-in wires connecting the electrodes directly or through an operating circuit to the means suitable for electrically connecting to a socket.

U.S. Pat. No. 6,633,128, granted Oct. 14, 2003, to Lilies, et al., teaches of a discharge lamp with spiral shaped discharge tube comprising a low-pressure discharge lamp with a double spiral shaped discharge tube including two spiral shaped tube portions. The tube portions define a central axis of the discharge tube. A cold chamber portion connects the ends of the spiral shaped tube portions. The cold chamber portion has a first transversal dimension substantially perpendicular to the central axis that is larger than the diameter of the tube portions. The cold chamber portion further has a second transversal dimension substantially parallel to the central axis. The second transversal dimension of the cold chamber portion substantially corresponds to the diameter of the tube portions.

U.S. Pat. No. 6,650,042, granted Nov. 18, 2003, to E. E. Hammer, discloses a low-wattage fluorescent lamp having at least one mercury cold spot region effective to maintain the mercury in the lamp at less than 30 degrees C., preferably 25.degrees C., in an enclosed lamp fixture. The lamp also features a reduced distance between electrodes resulting in less power being required to sustain an electric arc discharge during operation of the lamp. The lower power electric arc generates less heat to raise the temperature of mercury vapor within the lamp.

U.S. Pat. No. 6,731,070, granted May 4, 2004, to R. P. Scholl, et al., discloses a low-pressure gas discharge lamp having a gas discharge vessel containing a gas filling with a chalcogenide of the elements of the fourth main group of the periodic systems of elements and a buffer gas, and having inner or outer electrodes and means for generating and maintaining a low-pressure gas discharge.

U.S. Pat. No. 6,741,023, granted May 25, 2004, to A. Pirovic, discloses an electrode shield for a fluorescent tanning lamp comprising an open cup encircling a filament or electrode increasing the service life of the fluorescent tanning lamp. The cup having an open end acts as a shield reducing the sputtering of impurities onto the glass tube and contaminating the phosphor surface. In one embodiment, the cup is electrically and thermally coupled to an electrode support. The life of the fluorescent tanning lamp is greatly increased despite the use of relatively high currents and large number of on and off cycles.

Therefore, what is needed is a double helical, compact fluorescent lamp that has a plurality of cooling points that will allow the lamp to operate in a vertical position, with the apex facing upwardly, or with the lamp mounted in a horizontal plane, in any rotatable angle about the horizontal axis of the lamp, without degradation of the luminous output of the lamp.

It is therefore an object of the present invention to provide a plurality cooling points about the periphery of a bi-helical compact fluorescent lamp, said cooling points being arranged about the periphery of the spiraled coils to provide a constant luminous output of the lamp, regardless of its positional angle from the vertical axis of orientation.

It is another object of the present invention to provide a plurality cooling points about the periphery of a bi-helical compact fluorescent lamp, said cooling points being arranged about the inner periphery of the spiraled coils to provide a constant luminous output of the lamp, regardless of its positional angle from the vertical axis of orientation.

It is still another object of the present invention to provide a plurality cooling points about the periphery of a bi-helical compact fluorescent lamp, said cooling points being arranged about the periphery of the spiraled coils at the distal ends to provide a luminous output of the lamp, when operated in a horizontal plane, equivalent to its operation in a vertical position.

It is still yet another object of the present invention to provide a plurality cooling points about the periphery of a bi-helical compact fluorescent lamp, where at least one of said cooling points being arranged proximately at the vertex joining the spiraled coils to provide a luminous output of the lamp, when operated in a vertical position, equivalent to its operation in a horizontal plane.

It is yet still another object of the present invention to provide a cooling point chamber that is an enlargement of the diameter of the lamp tubing, the length preferably not exceeding five diameters, creating a chamber having an increased volume.

An additional object of the present invention is to provide a plurality of cooling point chambers that are shaped as ellipsoidal convexities along the periphery of the tubing.

Yet, another object of the present invention is to provide a plurality of cooling point chambers that are shaped as ellipsoidal convexities along the inner periphery of the tubing.

Yet still another object of the present invention to provide a plurality of cooling point chambers, whose enlargements increase the diameter of the tubing, to decrease the temperature of the mercury vapor where the mercury vapor condenses and is deposited in said respective cooling point.

It is a final object of the present invention to provide a plurality of cooling point chambers having a plurality of enlargements along the length of the tubing; said cooling point chambers being of any arbitrary, generalized geometrical shape whose function is to decrease the temperature of the mercury vapor so that the mercury vapor condenses and is deposited in said respective cooling point.

These and other objects, features, and advantages of the present invention will become apparent from reading the following detailed description, the accompanying drawings, and the appended claims.

### SUMMARY OF THE INVENTION

It has been demonstrated experimentally that by positioning a cold chamber at the apex of a spring wound compact fluorescent lamp, whose cross-section is shaped ellipsoidal where the major axis of the ellipsoid is in a vertical position, being the highest point and ovately upright, and when operated in a vertical burn position, a 23-watt lamp typically provides a luminous output ranging from 1600 to 1650 lumens.

However, when the same lamp is positioned in the horizontal plane, where it is radially orthogonal to the vertical axis, the luminous output decreases to only 1350 to 1400 lumens, and has a shorter life expectancy than when operated in the upright position.

But with the present invention, by placing an enlargement, a cooling point shaped as an ovate convexity, positioned near the last turn on one-half of the spiral wound tubing and another cooling point at the vertex, then the same 23-watt lamp, when mounted in either the horizontal or upright position, produces a luminous output of 1550 lumens.

For a larger, higher-wattage spirally wound fluorescent lamp that uses a greater quantity of mercury, such as with a 42-watt lamp, two cooling points, each shaped as an ovate convexity, are positioned near the last turn on each leg of the spiral wound tubing, as well as one at the vertex at the mid-point of the tubing.

Still additional cooling points may be added along the periphery, such as utilizing three cooling points angularly separated by 120 degrees or four cooling points that are each angularly separated by 90 degrees, so that the lamp, when operated in a horizontal plane, can be placed at any arbitrary rotational angle without any degradation of the luminous output.

### BRIEF DESCRIPTION OF THE DRAWINGS

The present invention is pictorially illustrated in the accompanying drawings that are attached herein.

FIG. 1 is a side view of a bi-helical, spirally wound, compact fluorescent lamp, having a convex, ovate cold chamber protruding upwardly and lying horizontally at the apex of the lamp, connecting the ends of the spirally shaped portion, and a second convex, ovate cold chamber protruding downwardly on the final turn of the left-half portion of spiral shaped tube prior to entering the base of the lamp.

FIG. 2 is a top view of the bi-helical, spirally wound, compact fluorescent lamp, of FIG. 1, having a first convex cooling chamber at the vertex of the lamp, and a second convex cooling chamber facing downwardly at the first distal extremity of the left-half portion of the spirally wound tubing.

FIG. 3 is a side view of a bi-helical, spirally wound, compact fluorescent lamp, of the present invention, having a first cooling point at the apex of the lamp, and a second cooling point facing inwardly on the first distal turn of the first-half portion of the tubing.

FIG. 3A is a top view of the bi-helical, spirally wound, compact fluorescent lamp, of the present invention, having a first cooling point at the apex of the lamp, and a second cooling point facing inwardly on the first distal turn of the first-half portion of the tubing.

FIG. 3B is a side view of a bi-helical, spirally wound, compact fluorescent lamp, of the present invention, showing the left hand side spiral wound tube, having a first cooling point at the apex of the lamp, and a second cooling point facing inwardly on the first distal turn of the first-half portion of the tubing.

FIG. 3C is a top view of the bi-helical, spirally wound, compact fluorescent lamp, of the present invention, showing the right hand side spiral wound tube, having a first cooling point at the apex of the lamp, and a second cooling point facing inwardly on the first distal turn of the second-half portion of the tubing.

FIG. 4 is a side view of a bi-helical, spirally wound, compact fluorescent lamp, of the present invention, having a first cooling point at the apex of the lamp, a second cooling point facing inwardly on the first distal extremity of the left-half portion of the tubing, and a third cooling point facing inwardly on the first distal extremity of the right-half portion of the tubing.

FIG. 4A is a top view of the bi-helical, spirally wound, compact fluorescent lamp, of the present invention, having a first cooling point at the apex of the lamp, a second cooling point facing inwardly on the first distal turn of the left-half portion of the tubing, and a third cooling point facing inwardly on the first distal turn of the right-half portion of the tubing.

FIG. 4B is a side view of a bi-helical, spirally wound, compact fluorescent lamp, of the present invention, showing the left hand side spiral wound tube, having a first cooling point at the apex of the lamp, a second cooling point facing inwardly on the first distal turn of the left-half portion of the tubing, and a third cooling point facing inwardly on the first distal turn of the right-half portion of the tubing.

FIG. 4C is a top view of the bi-helical, spirally wound, compact fluorescent lamp, of the present invention, showing the right hand side spiral wound tube, having a first cooling point at the apex of the lamp, a second cooling point facing inwardly on the first distal turn of the left-half portion of the tubing, and a third cooling point facing inwardly on the first distal turn of the right-half portion of the tubing.

FIG. 5 is a side view of a bi-helical, spirally wound, compact fluorescent lamp, of the present invention, having a first cooling point at the vertex of the lamp, a second cooling point facing inwardly at the first distal extremity of the left-half portion of the tubing, a third cooling point facing inwardly at the first distal extremity of the right-half portion of the tubing, a fourth cooling point facing inwardly and orthogonal to the second and third cooling points, and a fifth cooling point oppositely disposed to the fourth cooling point.

FIG. 5A is a top view of a bi-helical, spirally wound, compact fluorescent lamp, of the present invention, having a first cooling point at the vertex of the lamp, a second cooling point facing inwardly at the first distal extremity of the left-half portion of the tubing, a third cooling point facing inwardly at the first distal extremity of the right-half portion of the tubing, a fourth cooling point facing inwardly and orthogonal to the second and third cooling points, and a fifth cooling point oppositely disposed to the fourth cooling point.

FIG. 6 is a side view of another configuration of the compact fluorescent lamp that illustrates a conventional double spiral shaped, having a flattened ovate cold chamber lying horizontal at the apex of the lamp and connecting the ends of the spirally shaped portion.

### DETAILED DESCRIPTION OF THE INVENTION

The light output of a low-pressure mercury vapor lamp is determined by the saturated mercury vapor pressure which is determined by the temperature of the liquid mercury deposited somewhere on the inner wall of the lamp. In a stabilized lamp this is the coldest part of the bulb: the “cold chamber”, “cold spot”, or “cooling point”. It is there that the saturated mercury vapor pressure is determined from the cold-spot temperature. More specifically, in accordance with Boyle's Law, P₁ V₁ T₁=P₂ V₂ T₂, where P₁ V₁ T₁ are the product of a first pressure, volume, and temperature, which equals the product P₂ V₂ T₂ of the second pressure, volume, and temperature, although factors of the second multiplicand may have changed; and, for a fixed amount of gas kept at a fixed temperature, P and V are inversely proportional (while one increases, the other decreases. Further, by Charles Law for comparison between two volumes of gas at equal pressure.

$$\frac{{V}_{1}}{{T}_{1}} = \frac{{V}_{2}}{{T}_{2}} or \frac{{V}_{2}}{{V}_{1}} = \frac{{T}_{2}}{{T}_{1}} or {V}_{1} \cdot {T}_{2} = {V}_{2} \cdot {T}_{1}$$

Charles's law is a gas law and specific instance of the ideal gas law, which states that:
“At constant pressure, the volume of a given mass of an ideal gas increases or decreases by the same factor as its temperature (in Kelvin) increases or decreases.”
However, Gay-Lussac's other law, discovered in 1802, more appropriately states that:
“The pressure of a fixed amount of gas at fixed volume is directly proportional to its temperature in Kelvin.”
It may be expresses mathematically as:

$$\frac{P}{T} = k$$

Where:
   P is the pressure of the gas.
   T is the temperature of the gas (measured in Kelvin).
   k is a constant.

More simply expressed is that, for an increase in pressure, the temperature increases; as well as its corollary, for a decrease in pressure, the temperature decreases.

Therefore, at each cooling point chamber, where these tubular enlargements increase the volume of the chamber, determined by increasing the inside diameter of the tubing, the increased volume of the chamber results in a localized decrease in pressure of the entrained mercury vapor, thereby decreasing the temperature of the mercury vapor, and causing the mercury vapor to condense and deposit the mercury in said respective cooling point, in accordance with the equation as set forth by Gay-Lussac.

The normal light output is related to lamp temperature. Variations in light output of a typical compact fluorescent lamp will change with changes in temperature. The coldest spot on the lamp surface is the temperature that controls the light output of a compact fluorescent lamp. The optimum temperature for compact fluorescent lamps is typically 100° F. (38° C.). However, this will vary for different compact fluorescent lamps and ballasts, but the same general behavior will, with some exceptions, be observed.

Hence, the ambient temperature into which a compact fluorescent lamp is immersed can have a significant effect on the lamp's light output and its lamp efficacy. The temperature of the coldest spot on the surface of the lamp is where the mercury vapor will condense into liquid form, and this temperature (the “minimum lamp wall temperature”) controls the vapor pressure inside the lamp. The optimum lamp wall temperature for CF lamps is generally 100° F. (38° C.). At temperatures below the optimum, mercury vapor will condense at the cold spot, reducing the number of mercury atoms available to emit UV radiation: light output drops. At temperatures above the optimum, an excess of mercury vapor is present, absorbing the UV radiation before it can reach the phosphors; therefore the light output also decreases.

In the prior art, for a spiral shaped low-pressure discharge lamp, having a cold chamber at the top of the lamp, it has been determined experimentally that when operated in a vertical burn position, the lamp typically provides a luminous output ranging from 1600 to 1650 lumens. However, when the same lamp is positioned in the horizontal plane, the luminous output decreases to only 1350 to 1400 lumens, where the lamp has a shorter life expectancy.

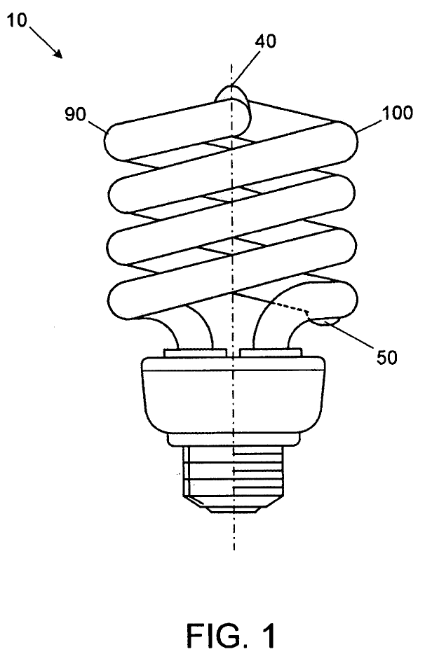

FIG. 1 is a side view of the present invention that illustrates a conventional double spiral shaped, compact fluorescent lamp, having a convex, ovate cold chamber protruding upwardly and lying horizontally at the apex of the lamp, connecting the ends of the spirally shaped portion and a second convex, ovate cold chamber projecting downwardly on the final turn of the left-half portion of spiral shaped tube 90 prior to entering the base of the lamp.

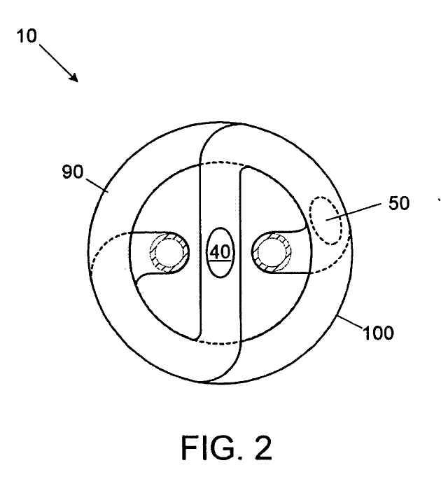

By the addition of an enlargement, a cooling chamber shaped as an ovate convexity, positioned downwardly near the last turn on one-half of the spiral wound tubing, together with the cooling chamber positioned upright at the vertex, as shown in FIG. 1 and the following FIG. 2, the compact fluorescent lamp will have the same luminous output when positioned and operated in either the horizontal or upright position.

FIG. 2 is a top view of the bi-helical, spirally wound, compact fluorescent lamp, of the present invention, having a first convex cooling chamber at the vertex of the lamp, and the addition of a second convex cooling chamber projecting downwardly at the first distal extremity of the left-half portion of the spirally wound tubing.

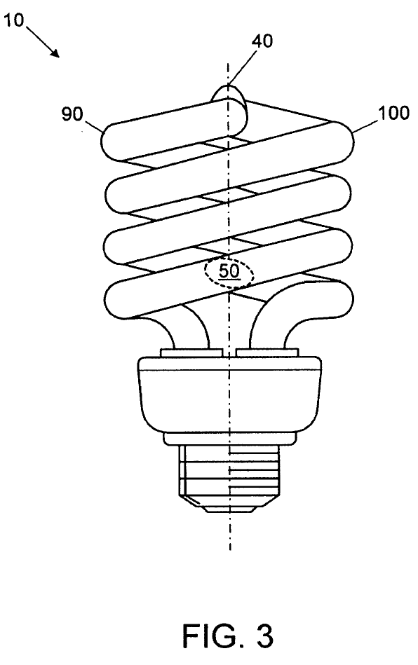

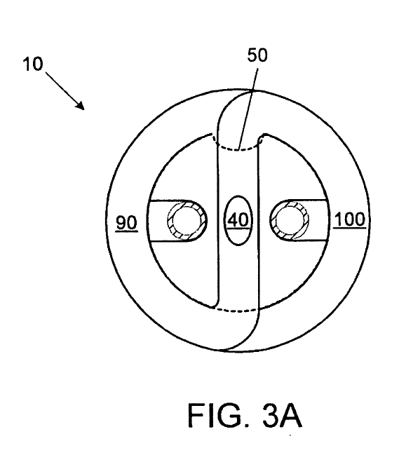

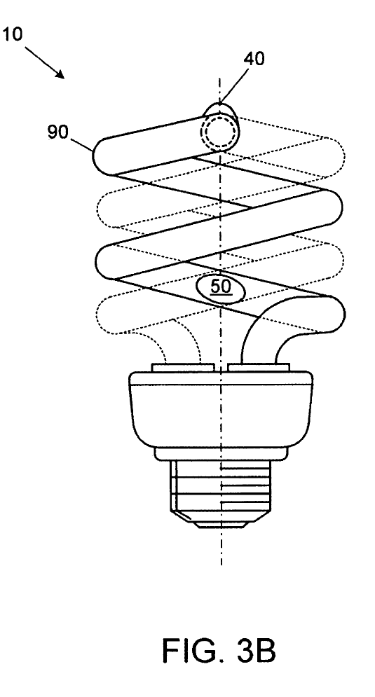

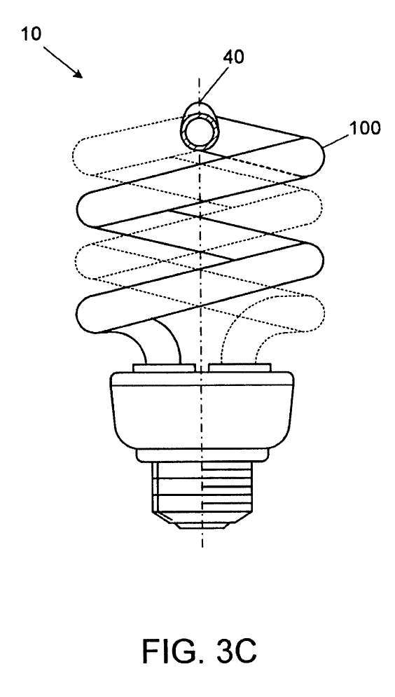

Turning now to FIGS. 3, 3A, 3B and 3C, there is shown a low-wattage bi-helical compact fluorescent lamp 10 of the present invention. These drawings relate to a low-wattage compact fluorescent lamp, having preferably a wattage rating of preferably 23-watts.

In this configuration of the present invention, there is provided two cooling points 40 and 50 to sustain constant luminous output when the lamp is mounted in either in an upright position or mounted lying in the horizontal plane. Each cooling point is an enlargement shaped preferably as an ellipsoidal convexity; the first cooling point 40 being at the vertex joining a first left-half spiral tube 90 with a right-half spiral tube 100, whose cross-section is ellipsoidal, where its major axis is in a vertical position, and the convexity so formed is in the highest upright position. The second ovate cooling point 50 is located at the distal end of the left-half portion of the spiral shaped tube 90, as shown in FIG. 3B, thereby giving nonsymmetrical operation for a low-wattage compact fluorescent lamp.

The volume of mercury entrained within a cooling point is such as to produce a temperature that is ideally 38 degrees Centigrade (100 degrees Fahrenheit). If the volume of the cooling point is too small, then the operating temperature of the mercury vapor will be above the optimum temperature of 38° C. Conversely, if the volume of the cooling point is oversized, then the operating temperature of the mercury vapor will be below the optimum temperature of 38° C.

Still another consideration for the placement of the cooling point chambers is where the cold chambers that are placed too far apart from each other, which may also result in a nonoptimal luminous output. The placement of these cold chambers requires careful placement to maintain a constant luminous output regardless into which plane the lamp is mounted in.

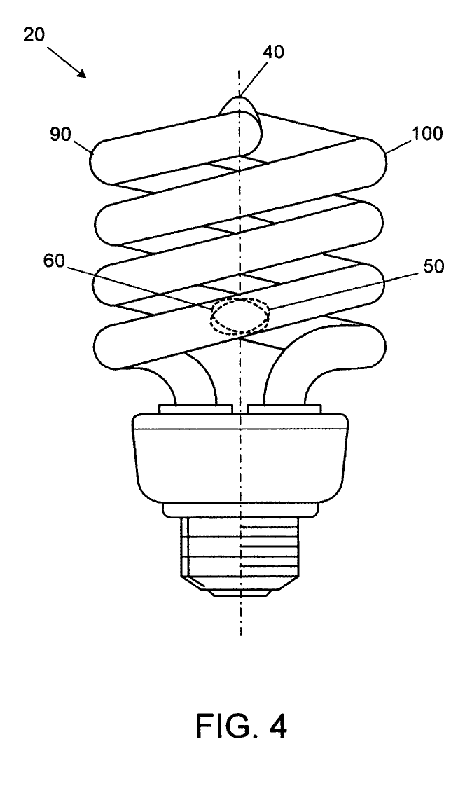

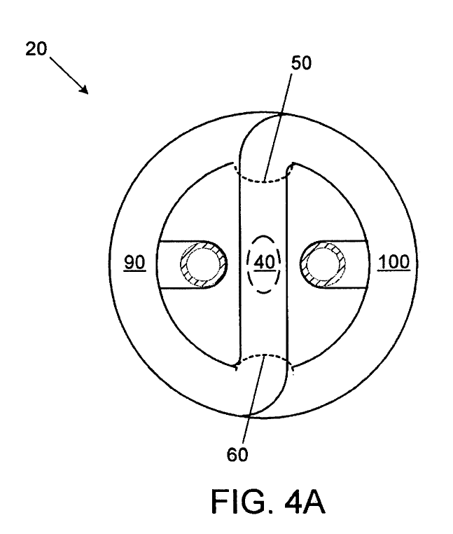

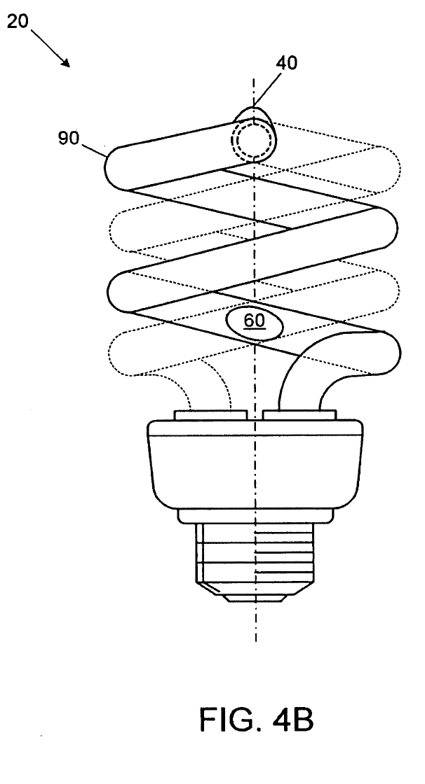

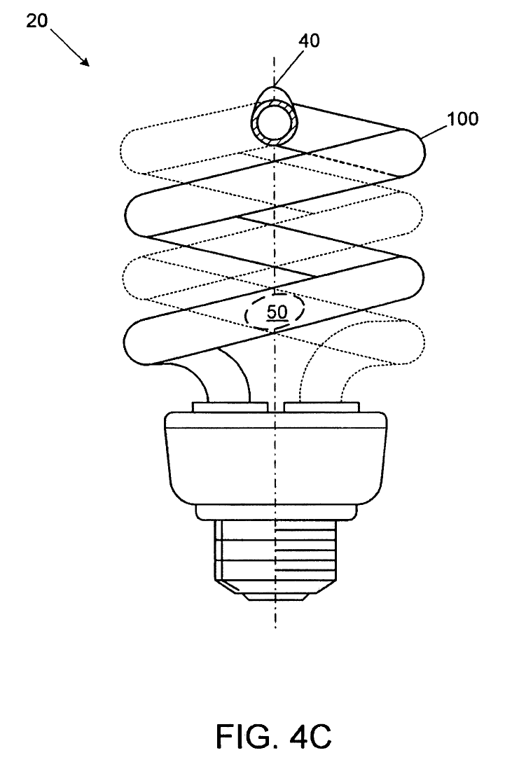

Therefore, as the wattage rating of a compact fluorescent lamp is increased, the volume of the mercury vapor increases, along with its operating temperature. Consequently, a medium-wattage compact fluorescent lamp 20 is provided as a second configuration, as shown in FIGS. 4, 4A, 4B and 4C, that has a single cooling point 40 at the vertex and two additional cooling points 50 and 60 at the distal ends of each half portion of the bi-helical lamp tubing 110.

In this second configuration of the present invention 20, there is provided three cooling points 40, 50 and 60 to sustain constant luminous output when the lamp is mounted in either in an upright position or mounted lying in the horizontal plane.

There is a total of three cooling points—one, 40, at the vertex for a vertical burn position and two, 50 and 60, located on the last turn near each leg. As the lamp wattage is increased, it becomes necessary increase the number of cooling points because of the greater quantity of mercury needed for proper lamp operation.

Each cooling point is an enlargement shaped preferably as an ovate ellipsoidal convexity; the first cooling point 40 being at the vertex joining a first left-half spiral tube 90 with a right-half spiral tube 100, whose cross-section is ellipsoidal, where its major axis is in a vertical position, and the convexity so formed is in the highest upright position. A second ovate cooling point 50 is located at the distal end of the left-half portion 90 of the spiral shaped tube, as shown in FIG. 4B and a third ovate cooling point 60 is located at the distal end of the right-half portion 100 of the spiral shaped tube, as shown in FIG. 4C.

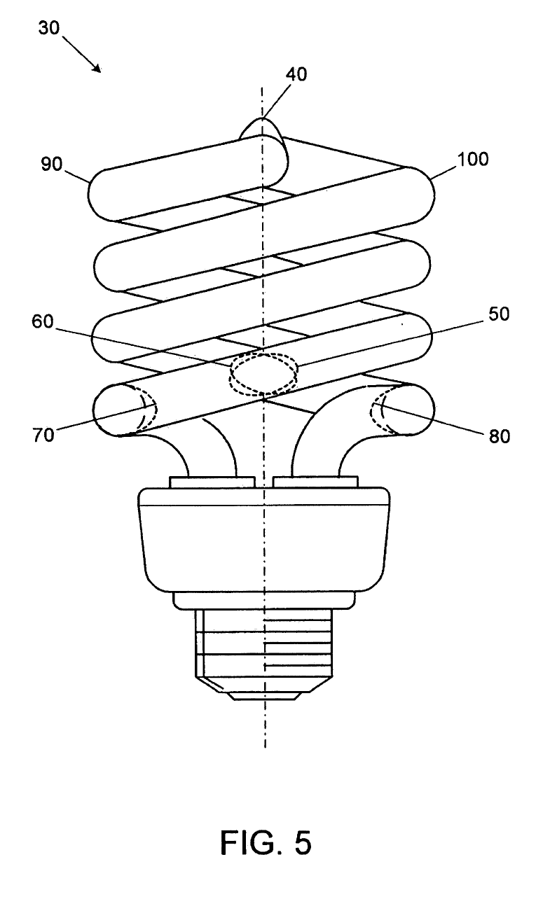

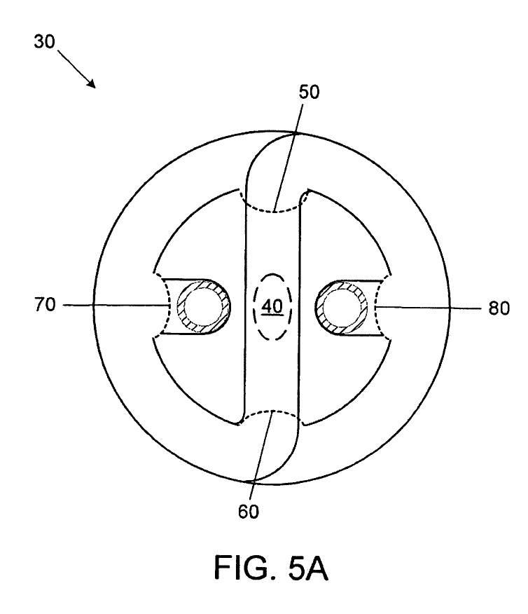

For even larger higher wattage compact fluorescent lamps 30, another possible cold chamber configuration is shown in FIGS. 5, 5A, 5B and 5C.

In this third configuration 30, there is one upright ovate cooling point 40 located at the vertex for operation in an upright position and four, equal-angularly spaced (90°) cooling chambers, 50, 60, 70 and 80, positioned along the periphery of the lowest turns of the bi-helical compact fluorescent lamp.

When this lamp is mounted in the horizontal plane, the use of four cooling points coact such as to resolve into a rotational vector where the lamp will provide an equivalent luminous output for any angle of rotation about the lamp's axis within the horizontal plane.

Even three, equal-angularly spaced (120°) cooling chambers (not shown), positioned along the periphery of the lowest turns of the bi-helical compact fluorescent lamp, may be found to provide stable rotational operation in the horizontal plane, but having a larger ripple effect of luminous output as the lamp is rotated about it's axis in a horizontal plane.

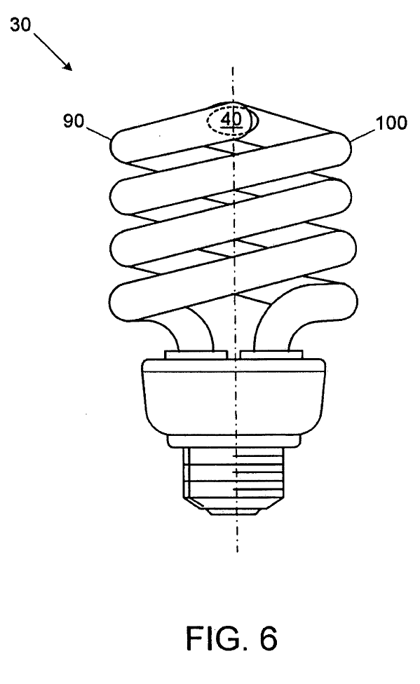

Turning now to FIG. 6, there is shown in another configuration, for the size, shape and position of a cooling point chamber at the vertex of the bi-helical compact fluorescent lamp. In this arrangement the cooling point 40 has a cross-section that is ellipsoidal, where its major axis is in a horizontal position, and the convexity so formed is symmetric and lies along its horizontal major axis.

However, in the preferred arrangement of the cold chamber of the present invention, by placing an enlargement, a cooling chamber shaped as an ovate convexity, positioned downwardly near the last turn on one-half of the spiral wound tubing and another cooling chamber positioned upright at the vertex, as shown in FIGS. 1 and 2, the compact fluorescent lamp will have the same luminous output when positioned and operated in either the horizontal or upright position.

In establishing during the manufacturing process, the filling of the tube with phosphorescent powder, the tube is laid preferably in a horizontal position and rotated slowly to evenly distribute the coating. If the phosphorescent coating is inadvertently applied to the interior of the lower cooling chamber, the cooling that will occur in the cooling chamber will be nullified because of the heating that occurs when the lamp is operated because of the phosphor coating generating heat, thereby preventing the condensing of mercury.

One skilled in the art will understand that the present invention as shown in the drawings and described above is exemplary only and not intended to be limiting. It will thus be seen that the objects of the present invention have been fully and effectively accomplished. Its arrangements have been shown and described for the purposes of illustrating the functional and structural principles of the present invention and is subject to change without departure from such principles. Therefore, this invention includes all modifications encompassed within the spirit and scope of the claims contained herein.

What is claimed is:

1) A double helical compact fluorescent lamp, comprising a spiral wound tubing formed by two spiral tubes joined at an apex with a first cooling point positioned at a vertex that joins a first left-half spiral tube with a right-half spiral tube of the lamp and a second cooling point positioned proximate to a lamp base; wherein each of said cooling points defines an enlargement of a spring lamp tube diameter, wherein the second cooling point protrudes downwardly at the first distal extremity just prior to a tube entry point in the lamp base.

2) A double helical compact fluorescent lamp as recited in claim 1, wherein a mercury vapor pressure and temperature in the lamp tube with the cooling points is adjusted by P/T=k, where the quotient of P, pressure, over T, temperature is k, constant.

3) A double helical compact fluorescent lamp as recited in claim 2, wherein the adjusted temperature of the mercury gas enables a radiation of 2537 angstroms for exciting a phosphor coating on an interior of the spiral tubing, and a lamp operation in a vertical position that is equivalent to its operation in a horizontal position.

4) A double helical compact fluorescent lamp comprising means for reducing a mercury vapor pressure in proportion to a reduction in a temperature of mercury vapor in the lamp, including means for adjusting a power density level of the lamp.

5) A double helical compact fluorescent lamp as recited in claim 4, wherein the means for reducing a mercury vapor pressure in proportion to a reduction in a temperature of mercury further comprises the steps of:
a) Adding cooling point chambers in the form of ovate ellipsoidal convexities situated strategically along a spiral wrapped tubing of the compact fluorescent lamp;
b) Ensuring that each cooling point chamber is sized properly to achieve a corresponding optimal mercury vapor temperature approximating 38 degrees C., wherein if a volume of the cooling point is too small, then an operating temperature of the mercury vapor will be above the optimum temperature of 38° C. and conversely, if the volume of the cooling point is oversized, then the operating temperature of the mercury vapor will be below the optimum temperature of 38° C.;
c) Positioning the cooling point chambers a maximal distance apart, wherein placing the cooling point chambers too far apart from each other may result in a nonoptimal luminous output, and a careful placement of the cold chambers is required to maintain a constant luminous output regardless in which plane the lamp is mounted.

6) A double helical compact fluorescent lamp as recited in claim 5, further comprising the step of processing the observed functions of a resulting pressure of the mercury vapor at each cooling point chamber, the pressure of the mercury vapor at the beginning of the spiral tubing, the pressure of the mercury vapor at the end of the spiral tubing, and the difference in pressure of the mercury vapor between the beginning of the spiral tubing, and the mercury vapor at the cooling point chamber, and the difference in pressure of the mercury vapor between the cooling point chamber, and the pressure of the mercury vapor at the end of the spiral tubing, wherein a desired constant pressure is achieved in according to Gay-Lussac's Law.

7) A double helical compact fluorescent lamp as recited in claim 6, further comprising the step of processing the observed functions of the resulting temperature of the mercury vapor at each cold point chamber, the temperature of the mercury vapor at the beginning of the spiral tubing, the temperature of the mercury vapor at the end of the spiral tubing, and the difference in temperature of the mercury vapor between the beginning of the spiral tubing, and the temperature of the mercury vapor at the end of the spiral tubing, and the difference in temperature of the mercury vapor between the cold point chamber, and the temperature of the mercury vapor at the end of the spiral tubing, according to Gay-Lussac's Law.

8) A double helical compact fluorescent lamp as recited in claim 7, wherein the step of processing the observed functions of the resulting pressure of the mercury vapor between each cold point chamber is achieved in accordance with Gay-Lussac's Law.

9) A double helical compact fluorescent lamp as recited in claim 8 in which the step of processing the observed functions of the resulting temperature of the gas mixture between each cold point chamber is achieved in accordance with Gay-Lussac's Law.

10) A double helical compact fluorescent lamp, comprising a spiral wound tubing formed by two spiral tubes joined at an apex with a first cooling point positioned at a vertex of the lamp and a second cooling point positioned proximate to a lamp base, near a last turn on one-half of the spiral wound tubing, further comprising a third cooling point positioned proximate to the lamp base, near a last turn on an opposite one-half of the spiral wound tubing, wherein a single cooling point is at the lamp vertex and two additional cooling points are located near a distal end of each half portion of the bi-helical lamp tubing to sustain constant luminous output when the lamp is mounted in either in an upright position or mounted lying in the horizontal plane.

11) The double helical compact fluorescent lamp as recited in claim 10, further comprising a fourth cooling point on the periphery of the tubing, wherein the first cooling point lies at the apex of the lamp with the second, third and fourth cooling points in an equal, angularly spaced configuration, 120° apart on the periphery of the lowest turns of the bi-helical compact fluorescent lamp, wherein at least one of said second, third and fourth cooling points is near a top of the lamp when horizontally positioned, which provides a stable lamp operation in a lamp rotation about its axis in a horizontal plane.

12) The double helical compact fluorescent lamp as recited in claim 13, further comprising a first cooling point located at the vertex for operation in an upright position and four, equal-angularly spaced (90°) cooling points positioned along the periphery of the lowest turns of the bi-helical compact fluorescent lamp, wherein a coaction of the four additional cooling points resolves into a rotational vector and, wherein the lamp provides an equivalent luminous output for any angle of rotation about the lamp's axis within the horizontal plane.
